(19) United States
(12) Patent Application Publication
(10) Pub. No.: US 2026/0009965 A1
(43) Pub. Date: Jan. 8, 2026

(54) METHOD FOR MANUFACTURING LENS UNIT, LENS UNIT, AND IMAGE CAPTURING DEVICE

(71) Applicant: CANON KABUSHIKI KAISHA, Tokyo (JP)

(72) Inventors: KYOSUKE YOKOTANI, Kanagawa (JP); SHUSUKE TOBITA, Kanagawa (JP)

(21) Appl. No.: 19/251,626

(22) Filed: Jun. 26, 2025

(30) Foreign Application Priority Data
Jul. 4, 2024 (JP) 2024-108026

(51) Int. Cl. G02B 7/02; G03B 17/12; G03B 30/00

(52) U.S. Cl. CPC G02B 7/025; G03B 17/12; G03B 30/00

(57) ABSTRACT

A method for manufacturing a lens unit including a lens, a lens barrel configured to hold the lens, and an adhesive with which the lens and the lens barrel are bonded, includes forming at least one recess in an outer peripheral region of the lens, starting supply of the adhesive from a position of the recess with respect to the lens held by the lens barrel, and stopping the supply of the adhesive in the position of the recess.

### BACKGROUND

### Field of the Technology

The present disclosure relates to a method for manufacturing a lens unit, a lens unit, and an image capturing device.

### Description of the Related Art

In recent years, enhancements in accuracy of complementary metal-oxide-semiconductor (CMOS) sensors and advances in communication technologies have enabled cameras to be installed in every device such as a mobile phone, and small lens units have been demanded. In such a small lens unit, a lens having a small diameter is widely used.

Such a small-diameter lens unit mainly includes a lens barrel and a plurality of lenses. Due to a magnitude relationship between lens diameters, assembly of the small-diameter lens unit is started from a lens on an object side relative to the lens barrel. In many cases, a lens on an image sensor side is assembled into the lens barrel last in a state where the plurality of lenses is stacked. For fixation of such a lens group to the lens barrel, it is known that an ultraviolet curable adhesive is generally used. The adhesive is applied between the image-sensor-side lens and an inner peripheral portion of the lens barrel, and thus the lens group is fixed, also serving as a seal.

Japanese Patent Application Laid-Open No. 62-272213 discusses, as a technique for fixing a lens to a lens barrel by using an adhesive, providing a recess or a groove to be filled with the adhesive on a lens surface, and the recess or the groove is filled with the adhesive to fix the lens to the lens barrel.

When the adhesive is supplied, there is a concern that uneven application thickness may occur in an optical axis direction. Curing of the adhesive in a state where such uneven application is present is undesirable from a viewpoint of lens position accuracy and a viewpoint of appearance.

### SUMMARY

The present disclosure is directed to an advantageous technique for applying an adhesive with which a lens is bonded.

According to an aspect of the present disclosure, a method for manufacturing a lens unit including a lens, a lens barrel configured to hold the lens, and an adhesive with which the lens and the lens barrel are bonded, includes forming at least one recess in an outer peripheral region of the lens, starting supply of the adhesive from a position of the recess with respect to the lens held by the lens barrel, and stopping the supply of the adhesive in the position of the recess.

Features of the present disclosure will become apparent from the following description of embodiments with reference to the attached drawings. The following description of embodiments are described by way of example.

### BRIEF DESCRIPTION OF THE DRAWINGS

FIG. 1 is a perspective view of a lens unit according to one exemplary embodiment.

FIG. 2 is a top view of the lens unit according to the present exemplary embodiment.

FIG. 3 is a sectional view of the lens unit taken along the line A-A of FIG. 2

FIG. 4A is a perspective view of a lens according to the present exemplary embodiment, and FIG. 4B is an enlarged view of an area B of the lens illustrated in FIG. 4A.

FIG. 5 is a sectional view of a lens unit according to a comparative example.

FIG. 6 is a perspective view of a lens according to the comparative example.

### DESCRIPTION OF THE EMBODIMENTS

Hereinafter, various exemplary embodiments, features, and aspects for carrying out the present technique will be described with reference to the drawings. However, the exemplary embodiment described below is one exemplary embodiment of the disclosure, and the present disclosure is not limited thereto. A common configuration will be described with reference to a plurality of drawings, and a description of configurations denoted by a common reference numeral will be omitted as appropriate.

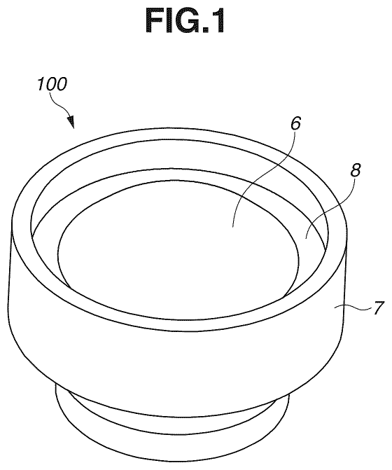

A lens unit 100 according to one exemplary embodiment is described with reference to FIGS. 1 to 3. An image capturing device including such a lens unit can be installed in a smart phone or a tablet terminal, a mobile phone having an image capturing function, or other communication devices.

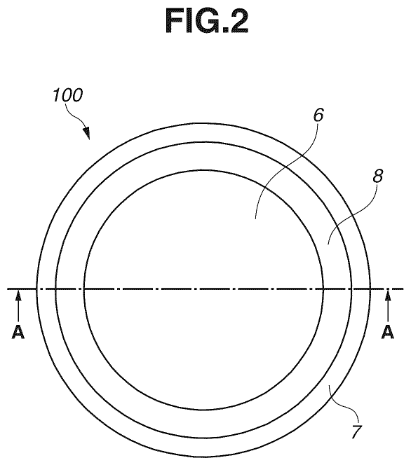

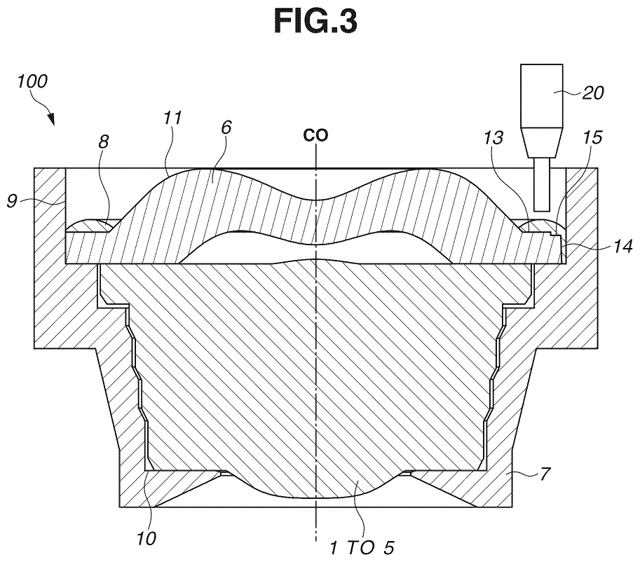

FIG. 1 is a perspective view of the lens unit 100. FIG. 2 is a top view of the lens unit 100. FIG. 3 is a sectional view of the lens unit 100 taken along line A-A of FIG. 2. The lens unit 100 includes a lens barrel 7 that holds lenses, six lenses 1 to 6 that are housed inside the lens barrel 7, and an adhesive 8 with which the lens 6 and the lens barrel 7 are bonded. The lens 1 is arranged on an object side, whereas the lens 6 is arranged on an image sensor side (not illustrated). The lens unit 100 does not necessarily have to be assembled from six lenses as long as two or more lenses are stacked. In FIG. 3, the lenses 1 to 5 are collectively illustrated for the sake of simplicity. A material for each lens used in the lens unit 100 can be plastic, glass, or the like as long as mechanical and optical performances of the lens can be satisfied.

The lens barrel 7 can have a cylindrical shape with openings on the object side and the image sensor side. The lenses 1 to 6 are housed inside the lens barrel 7 in a stacked state. Among these lenses, the lens 6 is engaged with an engagement portion 9 formed on an inner peripheral surface of the lens barrel 7, so that the lens 6 is positioned. On the object side of the inner peripheral surface of the lens barrel 7, a receiving surface 10 perpendicular to an optical axis direction CO is formed. The lens 1 comes into contact with the receiving surface 10, so that the lens 1 is positioned.

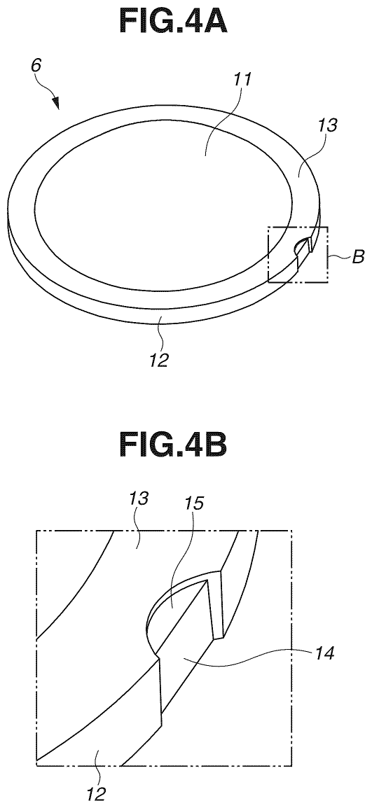

The adhesive 8 is provided to bond the lens barrel 7 and the lens 6. The adhesive 8 is arranged to be continuous from a bonding surface 13 (outer peripheral region) provided on an outer periphery of an optical surface 11 of the lens 6 to an inner surface of the engagement portion 9 of the lens barrel 7, which contacts the lens 6. Such an adhesive 8 is supplied from a nozzle 20 that is an adhesive supply unit. The adhesive 8 is supplied so as to contact the bonding surface 13 of the lens 6 and the entire circumference of the engagement portion 9 of the lens barrel 7, and then is cured. Thus, the lens 6 is bonded and fixed to the lens barrel 7. As a material of the adhesive 8, an acrylic photo-curable resin, an epoxy curable resin, or the like can be used. Among these materials, the acrylic photo-curable resin is desirable because of good moldability. Moreover, in a portion of the bonding surface 13 of the lens 6, at least one outer peripheral recess 14 is formed such that the adhesive 8 enters between the lens 6 and the lens barrel 7. A shape of the outer peripheral recess 14 of the lens 6 is described in detail with reference to FIGS. 4A and 4B.

FIG. 4A is a perspective view of the lens 6 which is employed in the lens unit 100. FIG. 4B is an enlarged view of an area B of the lens 6 illustrated in FIG. 4A. The lens 6 includes the optical surface 11, an outer peripheral surface 12, and the bonding surface 13. The outer peripheral surface 12 is engaged with the engagement portion 9 of the lens barrel 7 by contacting the engagement portion 9. The adhesive 8 is supplied to the bonding surface 13, and the bonding surface 13 is bonded. The bonding surface 13 is desirably provided outside an effective optical surface.

The outer peripheral surface 12 has a portion in which the outer peripheral recess 14 is formed. The outer peripheral recess 14 has a diameter that is slightly reduced in a radial direction. Furthermore, on the bonding surface 13, a bonding surface recess 15 is formed at a position of the outer peripheral recess 14. The bonding surface recess 15 has a thickness that is reduced in the optical axis direction CO.

It is assumed that a lens barrel in which a lens is housed and a supply unit that supplies an adhesive are relatively rotated in a state where a nozzle of the supply unit is brought close to a bonding region, and the adhesive is circumferentially supplied along an outer peripheral portion of the lens.

When the adhesive is supplied, there is a concern that uneven application in thickness may occur in an optical axis direction. Curing of the adhesive in a state where such uneven application is present is undesirable from a viewpoint of lens position accuracy and a viewpoint of appearance. Such uneven application may be smoothed if a certain amount of waiting time is provided between the supply of the adhesive to the outer peripheral portion of the lens and the curing of the adhesive. However, because such waiting time causes a time delay in lens unit assembly, it is undesirable.

The present exemplary embodiment provides an advantageous technique that can not only prevent occurrence of uneven application of an adhesive with which a lens is bonded, but also prevent a time delay in lens unit assembly.

### Lens Unit Manufacturing Method

An assembly process (manufacturing process) of the lens unit 100 is described. The assembly process includes: (1) a temporary assembly process by which the lenses 1 to 6 are housed inside the lens barrel 7; (2) a bonding process by which the lens is fixed inside the lens barrel 7 with the adhesive 8; and (3) a curing process by which the adhesive 8 is cured.

In the temporary assembly process, first, the lens 1, which is the closest to an object, is assembled to the lens barrel 7.

At this time, the lens 1 is inserted so as to come into contact with the receiving surface 10 of the lens barrel 7, and then the lenses 2 to 5 are stacked and assembled in order such that the lenses 2 to 5 are stacked on the lens 1. The lens 6, which is the last lens, is inserted such that the outer peripheral surface 12 of the lens 6 is engaged with the engagement portion 9 of the lens barrel 7, and the lens 6 is positioned with respect to the lens barrel 7. Accordingly, the lenses 1 to 6 are temporarily assembled to the lens barrel 7. Subsequent to the temporary assembly process, the bonding process by which

the temporarily assembled lens 6 is fixed to the lens barrel 7 is started. In the bonding process, the nozzle 20 is first moved to a supply start position where the outer peripheral recess 14 of the lens 6 is arranged, and supply of the adhesive 8 is started from a position above the outer peripheral recess 14. Then, the lens barrel 7 is rotated while the adhesive 8 is being supplied, and the nozzle 20 is moved so as to relatively circle around above the bonding surface 13.

Accordingly, the adhesive 8 is supplied to the entire circumference of the bonding surface 13. Alternatively, the nozzle 20 may be rotated instead of rotating the lens barrel 7.

When the nozzle 20 reaches the supply start position that is directly above the outer peripheral recess 14 again, rotation of the lens barrel 7 and the supply of the adhesive 8 are stopped. Accordingly, the supply start position and a supply end position of the adhesive 8 are set directly above the outer peripheral recess 14, so that the adhesive 8 can be supplied to the entire circumference of the bonding surface 13 without shortage of the adhesive 8, and the lens 6 can be sealed. Moreover, since the supply start position and the supply end position are set directly above the outer peripheral recess 14, the outer peripheral recess 14 and the bonding surface recess 15 function as an adhesive reservoir. Even in a case where the adhesive 8 is excessively supplied, an excess adhesive can be absorbed by the outer peripheral recess 14 and the bonding surface recess 15. Thus, even if the waiting time for smoothing the adhesive is not provided, the adhesive 8 can be supplied without being raised from another adhesive applied surface on the bonding surface 13. More specifically, the adhesive applied surface has the same height across the entire outer peripheral region immediately after the supply of the adhesive 8, so that the adhesive 8 can be cured immediately. While the position of the nozzle 20 is described using an example in which the nozzle 20 is positioned directly above the outer peripheral recess 14, the nozzle 20 may be positioned directly above the bonding surface recess 15.

After the supply of the adhesive 8, the curing process is performed. In a case where the adhesive 8 includes a photo-curable resin, the adhesive 8 is irradiated with an ultraviolet ray and cured. The curing process may be collectively performed on the entire circumference after the supply of the adhesive 8, or the bonding process and the curing process may be concurrently performed.

### COMPARATIVE EXAMPLE

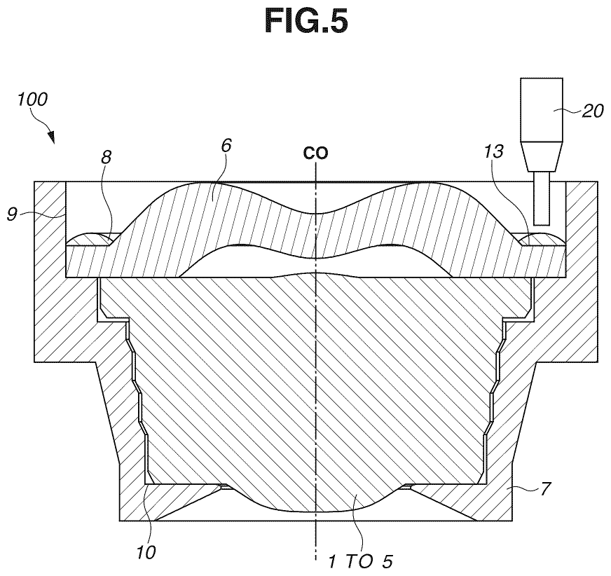

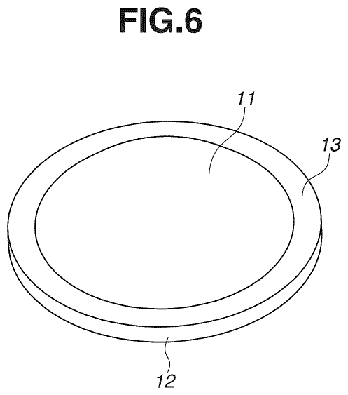

A comparative example in which an outer peripheral recess 14 and a bonding surface recess 15 are not provided on a lens 6 is described with reference to FIGS. 5 and 6. FIG. 5 is a sectional view of a lens unit 100 taken along the line A-A of FIG. 2. FIG. 6 is a perspective view of the lens 6 employed in the lens unit 100 illustrated in FIG. 5. In the comparative example illustrated in FIG. 5, a lens shape differs from that of the lens unit 100 illustrated in FIG. 3.

The lens 6 illustrated in FIG. 6 includes an optical surface 11, an outer peripheral surface 12 that is engaged with an engagement portion 9 of a lens barrel 7, and a bonding surface 13 to which an adhesive 8 is supplied. The bonding surface 13 is formed outside an effective optical surface on an image sensor side. However, the outer peripheral recess 14 and the bonding surface recess 15 are not formed.

A bonding process for bonding a lens unit according to the comparative example is described. Since the temporary assembly process prior to the bonding process is similar to that described in the above exemplary embodiment, a description thereof is omitted.

In the bonding process, a nozzle 20 is first moved to the bonding surface 13 of the lens 6, and supply of the adhesive 8 is started. Subsequently, the lens barrel 7 is rotated, so that the nozzle 20 is moved so as to relatively circle around above the bonding surface 13. When the nozzle 20 reaches directly above a supply start position again, rotation of the lens barrel 7 and the supply of the adhesive 8 are stopped. The supply start position and a supply end position of the adhesive 8 are substantially matched, so that the adhesive 8 can be supplied to the entire circumference of the bonding surface 13 without shortage of the adhesive 8, and the lens 6 can be sealed.

However, since the adhesive 8 at the supply start position and the adhesive 8 at the end of the supply overlap at the supply end position, the adhesive 8 is partially raised from another adhesive applied surface on the bonding surface 13. The adhesive applied surface is smoothed due to gravity over time. In the meantime, however, the adhesive cannot be cured by ultraviolet rays. Consequently, such time becomes the waiting time.

In a case where the lens 6 of the comparative example was used, the time for smoothing the adhesive 8, which was partially raised after the supply of the adhesive 8 ended, was used, and the waiting time was 10 seconds.

As described above in the present exemplary embodiment, providing the outer peripheral recess 14 and the bonding surface recess 15 on the lens 6 enables the adhesive 8 to be cured immediately after the supply of the adhesive 8, and enables the bonding process to be shortened by approximately 10 seconds compared to a case where the outer peripheral recess 14 and the bonding surface recess 15 are not provided. In short, in the present exemplary embodiment, uneven application of an adhesive with which a lens is bonded can be prevented, and a time delay in lens unit assembly can be prevented.

The present exemplary embodiment has been described using an example in which both the outer peripheral recess 14 and the bonding surface recess 15 are provided. However, one of the outer peripheral recess 14 and the bonding surface recess 15 can be provided. The present exemplary embodiment has been described using an example in which one outer peripheral recess 14 and one bonding surface recess 15 are provided. However, in a case where there are two or more locations where an adhesive supply amount increases, the numbers of outer peripheral recesses 14 and the bonding surface recesses 15 can be the same as the number of such locations.

The exemplary embodiment described above can be appropriately modified without departing from the technical idea.

According to the present disclosure, an advantageous technique is provided that can not only prevent occurrence of uneven application of an adhesive with which a lens is bonded, but also prevent a time delay in lens unit assembly can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-108026, filed Jul. 4, 2024, which is hereby incorporated by reference herein in its entirety.

What is claimed is:

1. A method for manufacturing a lens unit including a lens, a lens barrel configured to hold the lens, and an adhesive with which the lens and the lens barrel are bonded, the method comprising:
forming at least one recess in an outer peripheral region of the lens;
starting supply of the adhesive from a position of the recess with respect to the lens held by the lens barrel; and
stopping the supply of the adhesive in the position of the recess.

2. The method according to claim 1, wherein the supply of the adhesive is performed while the lens and a nozzle that supplies the adhesive are being relatively rotated.

3. The method according to claim 1, wherein the supply of the adhesive is performed on an entire circumference of the outer peripheral region of the lens.

4. The method according to claim 1, wherein the recess has a diameter that is slightly reduced in a radial direction.

5. The method according to claim 1, wherein the recess has a thickness that is reduced in an optical axis direction.

6. The method according to claim 1, wherein the recess has a diameter that is slightly reduced in a radial direction, and has a thickness that is reduced in an optical axis direction.

7. The method according to claim 1, wherein the adhesive is cured after the supply of the adhesive.

8. A lens unit comprising:
a lens;
a lens barrel configured to hold the lens; and
an adhesive with which the lens and the lens barrel are bonded,
wherein the lens has an outer peripheral region in which at least one recess is formed, and
wherein the adhesive is provided over an entire circumference of the outer peripheral region of the lens including the recess.

9. The lens unit according to claim 8, wherein a height of the adhesive is same over the entire circumference of the outer peripheral region of the lens.

10. The lens unit according to claim 8, wherein the recess has a diameter that is slightly reduced in a radial direction, and has a thickness that is reduced in an optical axis direction.

11. An image capturing device comprising the lens unit according to claim 8.
